(19) United States
(12) Patent Application Publication
(10) Pub. No.: US 2006/0066227 A1
(43) Pub. Date: Mar. 30, 2006

(54) Electronic device with dual display arrangement

(76) Inventors: James L. Virnich, Chicago, IL (US); Timothy M. McCune, Cary, IL (US)

Correspondence Address: MOTOROLA INC, 600 NORTH US HIGHWAY 45, ROOM AS437, LIBERTYVILLE, IL, 60048-5343, US

(21) Appl. No.: 10/950,019

(22) Filed: Sep. 24, 2004

(51) Int. Cl. H05B 33/00; H05B 33/02

(52) U.S. Cl. 313/505; 313/504; 313/509

(57) ABSTRACT

An electronic device (100) with a dual display arrangement has a housing (110) with a first view port (115) and a second view port (119). The electronic device (100) also has a display module (150) with a first display (152) viewable through the first view port (115), a second display (155) viewable through the second view port (119), and a light guide (151) configured to direct light emitted by the second display (155) for use as backlighting for the first display (152). The dual display arrangement allows an organic electroluminescent display (OLED) second display (155) to serve as a backlight source for a liquid crystal display (LCD) first display (152) as well as operate as a viewable second display (155).

### FIELD OF THE DISCLOSURE

This disclosure relates generally to a dual display arrangement and an electronic device using this dual display arrangement.

### BACKGROUND OF THE DISCLOSURE

Certain portable electronic devices, such as some cellular telephones, have more than one display. Often, these displays are in a back-to-back arrangement with a first display facing one direction and a second display facing an opposite direction. Other portable electronic devices, such as cordless telephones, laptop computers, personal digital assistants (PDAs), cameras, and remote controllers, could benefit from more than one display. Generally speaking, however, more displays lead to increased power consumption, increased manufacturing costs, increased device size, and more complex display circuitry.

There is an opportunity to make a dual display electronic device more efficient by re-using elements from one display in the other display. The various aspects, features and advantages of the disclosure will become more fully apparent to those having ordinary skill in the art upon careful consideration of the following Drawings and accompanying Detailed Description.

### BRIEF DESCRIPTION OF THE DRAWINGS

FIG. 1 shows a perspective view of an electronic device in an open position incorporating a dual display module according to a first embodiment.

FIG. 2 shows a perspective view of the electronic device in a closed position incorporating the dual display module according to the first embodiment.

FIG. 3 shows a cross-sectional side view of the electronic device in the open position incorporating the dual display module according to the first embodiment.

FIG. 4 shows an exploded view of the dual display module according to the first embodiment.

FIG. 5 shows a cross-sectional side view of a dual display module according to an alternate embodiment.

### DETAILED DESCRIPTION OF THE PREFERRED EMBODIMENTS

An electronic device with a dual display arrangement has a housing with a first view port and a second view port. The electronic device also has a display module with a first display viewable through the first view port, a second display viewable through the second view port, and a light guide configured to direct light emitted by the second display for use as backlighting for the first display. The dual display arrangement allows an organic electroluminescent display (OLED) to serve as a backlight for a liquid crystal display (LCD) as well as operate as a viewable display. This arrangement eliminates the need for separate light emitting diodes (LEDs) to backlight the LCD. Instead, a light guide channels light emitted from the rear of the OLED to backlight the LCD. If the OLED and the LCD are arranged back-to-back, a straightforward light guide can be used to create a thin dual display for an electronic device.

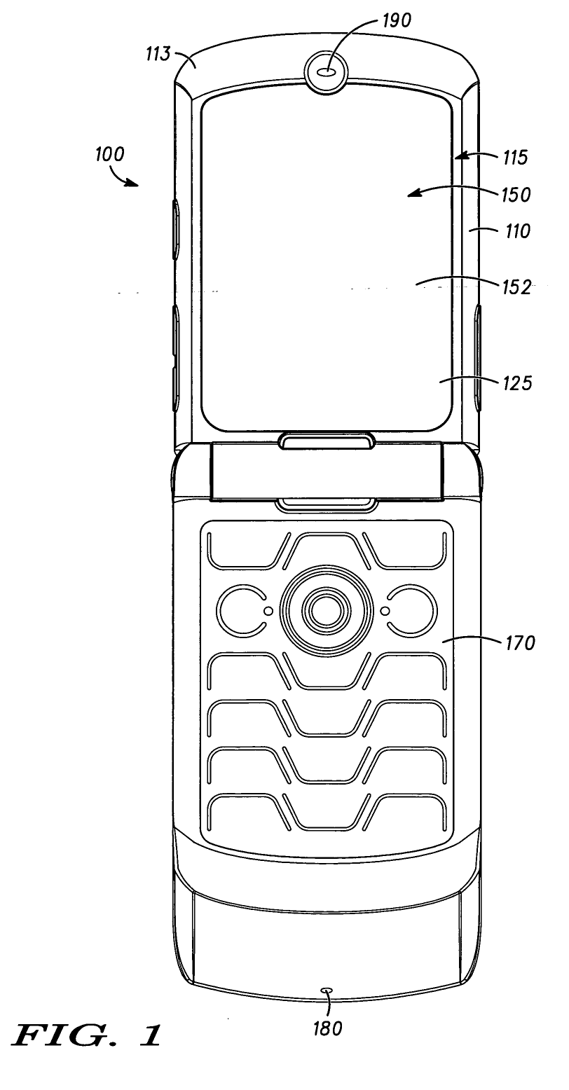

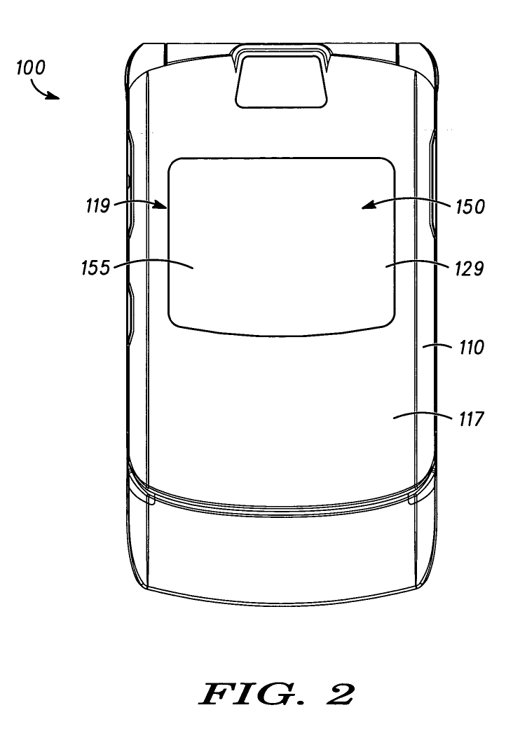

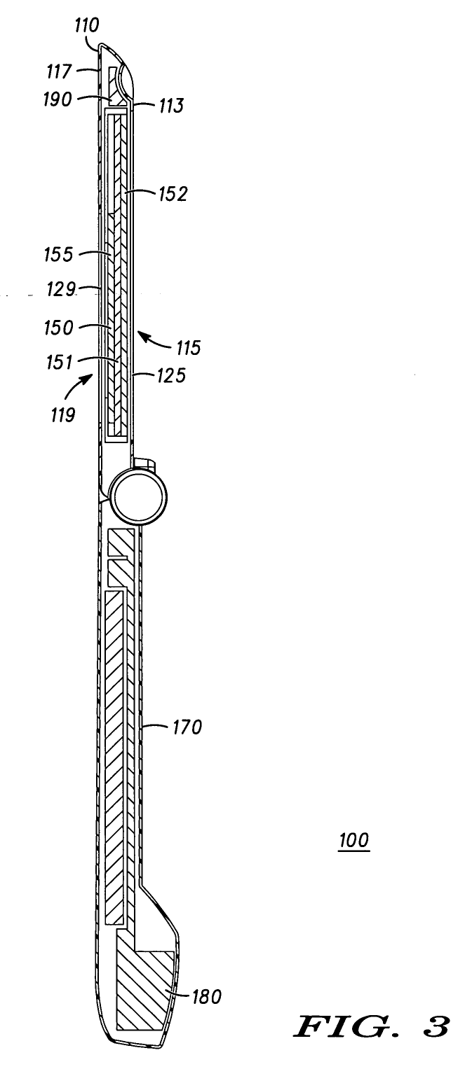

FIG. 1 shows a perspective view of an electronic device 100 in an open position incorporating a dual display module 150 according to a first embodiment. Meanwhile, FIG. 2 shows a perspective view of the electronic device 100 in a closed position incorporating the dual display module 150 according to the first embodiment. Finally, FIG. 3 shows a cross-sectional side view of the electronic device 100 in the open position incorporating the dual display module 150 according to the first embodiment. In this first embodiment, the electronic device 100 is a foldable mobile terminal or cellular telephone. The electronic device can be alternately implemented as a non-foldable mobile terminal or cellular telephone, a cordless telephone, a pager, a portable computer such as a laptop or notebook personal computer, a digital still camera, a digital video camera, a personal digital assistant (PDA), a remote controller, or another electronic device with more than one display.

The upper portion of the electronic device 100 has a housing 110 for holding the dual display module 150. This first embodiment shows a back-to-back dual display module, which is useful in the foldable mobile terminal or cellular telephone environment being described. The housing 110 has a first side 113 with a first view port 115 for viewing a first display 152. FIG. 2 and FIG. 3 show that the housing 110 also has a second side 117 with a second view port 119 for viewing a second display 155 of the dual display module 150. As shown in FIG. 3, between the rear of the first display 152 and the rear of the second display 155 is a light guide 151. In this embodiment, the view ports 115, 119 are covered with substantially transparent lenses 125, 129 to protect the displays 152, 155 from damage by dust, dirt, oils, or physical contact.

Because this first embodiment shows a foldable mobile terminal or cellular telephone, the second view port 119 is visible and the first view port 115 is covered when the electronic device 100 is in the closed position shown in FIG. 2. As shown in FIG. 3, both the first view port 115 and the second view port 119 are visible when the electronic device 100 is in the open position. The first view port 115 is visible on the first side 113 of the housing 110 while the second view port 119 is visible on the second side 117 of the housing 110.

A user interface of the electronic device 100 includes, in addition to the dual displays 152, 155, a loudspeaker 190, a microphone 180, and a keypad 170. The electronic device 100 also has other elements necessary to a mobile terminal or cellular telephone, which are not presented here for the sake of clarity. Such other elements include an antenna, a radio frequency transmitter, a radio frequency receiver, baseband circuitry, a microprocessor, a controller, memory, and a battery.

Although this first embodiment shows back-to-back displays, the displays do not need to be positioned back-to-back (i.e., at 180 degrees relative to each other with at least one display fully overlapped by the other display). Alternately, the dual displays can implemented in other configurations such as facing opposite directions and positioned side-by-side (i.e., at 180 degrees relative to each other with no overlap of the displays), facing opposite directions and partially overlapping (i.e., at 180 degrees relative to each other with neither display being fully overlapped by the other display), facing the same direction and positioned side-by-side, and facing yet other directions (e.g., at 90 degrees relative to each other), etc.

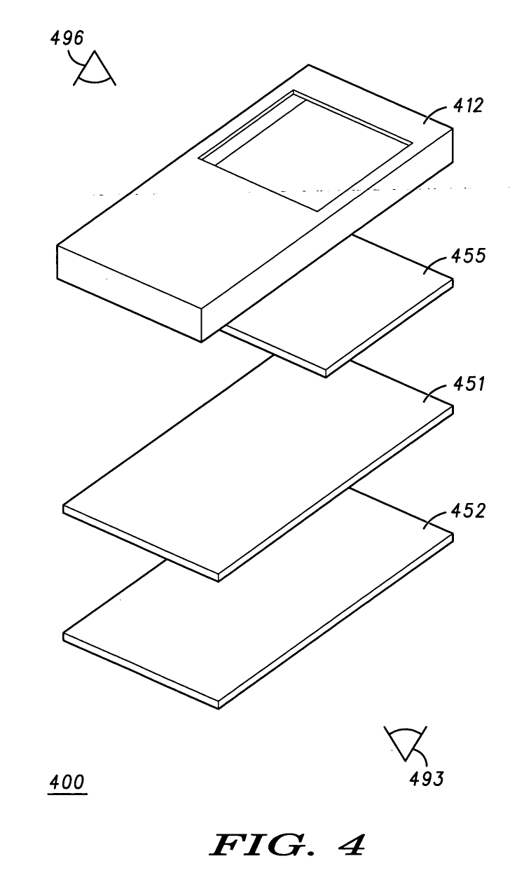

FIG. 4 shows an exploded view of the dual display module 400 according to the first embodiment. A first display 452 (such as the first display 152 shown in FIG. 1 and FIG. 3) is viewable from an intended first viewing position 493, and a second display 455 (such as the second display 155 shown in FIG. 2 and FIG. 3) is viewable from an intended second viewing position 496. In this first embodiment, the first display 452 is a liquid crystal display such as a thin film transistor (TFT) display or a color super twisted nematic (CSTN) display. The second display 455 an organic electroluminescent light emitting diode display in this first embodiment. Between the first display 452 and the second display 455 is a light guide 451 that directs light emitted by the OLED for use as backlighting for the LCD. An opaque frame 412, such as a metal frame, around the perimeter of the second display 455 helps hold together the dual display module 400, masks exposed portions of the larger first display 452 from the smaller second display 455, and provides stability and rigidity to the dual display module 400.

The first display 452 is designed to be a main display for a portable electronic device. Thus, the first embodiment uses a high-resolution color LCD as the first display 452. Of course, a low-resolution and/or monochromatic LCD can be implemented as the first display 452. The second display 455 is intended to be a secondary display and uses a smaller multi-color OLED. The second display 455 can show, for example, a calling line identity (CallerID), the current date and time, or indicate the owner of the electronic device. By using a multi-color OLED, the generation of colored light for backlighting the LCD can be controlled by an OLED display driver, or color filters can be used to change colored light from the OLED to white light for backlighting the LCD. Alternately, a monochromatic OLED can be used as the second display 455, and color filters can be used to provide multi-colored backlighting for the first display 452.

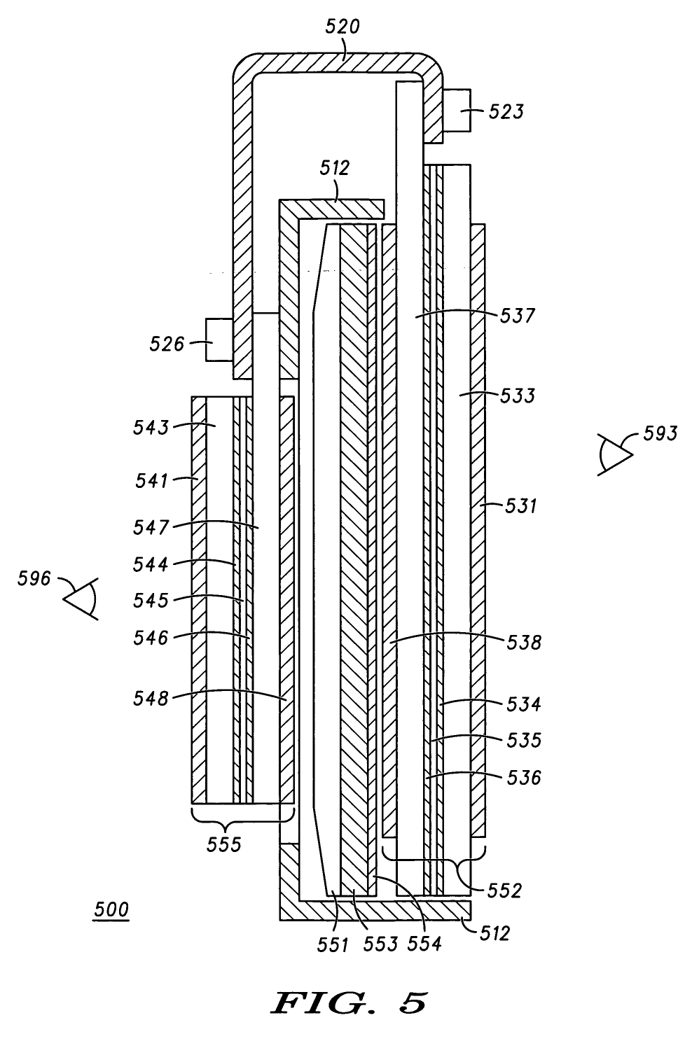

FIG. 5 shows a cross-sectional view of a dual display module 500 according to an alternate embodiment. In this alternate embodiment, the first display 552 is a liquid crystal display and the second display 555 is an organic electroluminescent display. Note that the first display 552 and the second display 555 need not be the same size in either height or width, nor do they need to be facing 180 degrees relative to each other or either fully or partially overlapping. In this alternate embodiment, the second display 555 is designed to be smaller in height than the first display 552 but similar in width.

The first display 552 in this alternate embodiment is implemented as a liquid crystal display (LCD). The LCD can use TFT, CSTN, or other type of display technology. The LCD can be black-and-white or color. FIG. 5 shows the various layers of the first display 552. These layers include a first front polarizer 531 for the first display 552, a first front transparent substrate 533 for the first display 552, a first front transparent electrode layer 534, a liquid crystal layer 535, a first rear transparent electrode layer 536, a first rear transparent substrate 537 for the first display 552, and a first rear polarizer 538 for the first display 552. Note that “front” and rear” . . . for the first display layers are relative to the expected viewing position 593 of the first display 552.

The first front polarizer 531 and the first rear polarizer 538 are optional. The first front transparent substrate 533 and the first rear transparent substrate 537 are constructed from glass, plastic, or the like. The first front transparent electrode layer 534 and the first rear transparent electrode layer 536 are constructed from indium tin oxide (ITO), indium-doped zinc oxide (IZO), or the like. The liquid crystal layer can use twisted nematic, super-twisted nematic, cholesteric, or other types of liquid crystal materials.

The second display 555 in this alternate embodiment is implemented as an organic electroluminescent display (OLED). The OLED can be a monochromatic or multi-color OLED. FIG. 5 shows the various layers of the second display 552. These layers include a second front polarizer 541 for the second display 555, a second front transparent substrate 543 for the second display 555, a second front transparent electrode layer 544, an organic electroluminescent layer 545, a second rear transparent electrode layer 546, a second rear substrate 547 for the second display 555, and a second rear polarizer 548 for the second display 555. Note that “front” and rear” are relative to the expected viewing position 596 of the second display 555.

The second front polarizer 541 and the second rear polarizer 548 are optional. The second front transparent substrate 543 and the second rear transparent substrate 547 are constructed from glass, plastic, or the like. The front transparent electrode layer 544 (anode) and the rear transparent electrode layer 546 (cathode) are constructed from indium tin oxide (ITO), indium-doped zinc oxide (IZO), or the like. The electroluminescent layer can use small molecule or polymer construction.

Instead of using LEDs as light sources for a conventional backlight for the LCD, light emitted by the OLED is used for backlighting the LCD. A light guide 551 between the first display 552 and the second display 555 channels light from the rear of the OLED through an optical sheet or diffuser 553 to the rear of the LCD. A color filter layer 554, shown between the light guide 551 and the rear of the first display 552 in this embodiment, can also be included.

An opaque frame 512, such as a metal frame, helps hold together the display module 500, masks exposed portions of the larger first display 552 from the smaller second display 555, and provides stability and rigidity to the display module 500. A flexible circuit 520 provides control signals to a first display driver 523 to control the first display 552 and to a second display driver 526 to control the second display 555.

This embodiment uses two separate display drivers 523, 526 that can be independently controlled or controlled jointly. For example, the second display 555 might be considered a “main display” when the electronic device is in a closed position (such as the electronic device 100 shown in FIG. 2). Thus, the control for the second display 555 does not consider what image is showing on the first display 552. When the electronic device 100 is in an open position (such as the electronic device 100 shown in FIG. 1), however, the second display 552 might be considered a “secondary display.” Thus, the second display 555 produces a uniform white light to be used to backlight the first display 552. Alternate to a uniform white light, the second display 555 could be driven to certain color patterns to provide colored light for backlighting the first display 552. If the two displays are completely independent, then the light produced by the second display 555 does not depend on whether the electronic device is opened or closed or whether the first display 552 is active or inactive.

Although the larger display (the first display 552) is shown as an LCD and the smaller display (the second display 555) is shown as an OLED in this alternate embodiment, the OLED display could be larger than the LCD display. Various factors, such as power consumption expectations, expectations for color quality (e.g., 256 colors, 1024 colors, or more), expectations for screen resolution, screen size demands, the specific application for a particular electronic device, and improvements in OLED and LCD technology, can affect the implementation of the dual display module. Note that if the OLED has a larger display area than the LCD, a partial display mode for the OLED can be used to conserve power or vary the backlight intensity. If the OLED has a smaller display area than the LCD, the OLED will be “on” whenever either display is in use.

Back-to-back display modules enable thinner, smaller, and/or less complex light guides to channel light from the OLED to the LCD to use as LCD backlighting. As discussed earlier, however, the display module need not be back-to-back and could instead be facing directions other than 180 degrees relative to each other. Additionally, the relative sizes of the first display and the second display can be varied, as well as the amount of overlap between the first display and the second display.

Thus, the dual display arrangement provides two displays and an alternative to traditional backlighting. By using light generated by an OLED to backlight an LCD, a conventional LED-based backlight can be eliminated. Given the larger light-generating area of an OLED relative to conventional LED-based backlighting, a thinner light guide can channel light from the OLED to the rear of the LCD. These changes can result in a thinner dual display module.

While this disclosure includes what are considered presently to be the preferred embodiments and best modes of the invention described in a manner that establishes possession thereof by the inventors and that enables those of ordinary skill in the art to make and use the invention, it will be understood and appreciated that there are many equivalents to the preferred embodiments disclosed herein and that modifications and variations may be made without departing from the scope and spirit of the invention, which are to be limited not by the preferred embodiments but by the appended claims, including any amendments made during the pendency of this application and all equivalents of those claims as issued.

It is further understood that the use of relational terms such as first and second, top and bottom, and the like, if any, are used solely to distinguish one from another entity, item, or action without necessarily requiring or implying any actual such relationship or order between such entities, items or actions.

We claim:

1. An electronic device comprising:
a housing with a first view port and a second view port; and
a display module including:
a first display viewable through the first view port;
a second display viewable through the second view port; and
a light guide configured to direct light emitted by the second display for use as backlighting for the first display.

2. An electronic device according to claim 1 wherein the first display is a liquid crystal display.

3. An electronic device according to claim 1 wherein the second display is an organic electroluminescent display.

4. An electronic device according to claim 1 wherein the first view port and the second view port face opposite directions.

5. An electronic device according to claim 1 wherein the display module further comprises:
an opaque frame around the perimeter of the second display.

6. An electronic device according to claim 1 wherein the electronic device is foldable to a closed position where the first view port is covered and the second view port is visible.

7. An electronic device according to claim 1 wherein the electronic device is foldable to an open position where the first view port is visible and the second view port is visible.

8. A dual display arrangement comprising:
a liquid crystal display having:
a first front transparent substrate;
a first front transparent electrode;
a liquid crystal layer;
a first rear transparent electrode;
a first rear transparent substrate;
an organic electroluminescent display having:
a second rear transparent substrate;
a second rear transparent electrode;
an organic electroluminescent layer;
a second front transparent electrode;
a second front transparent substrate; and
a light guide for directing light received through the second rear transparent substrate to the first rear transparent substrate.

9. A dual display arrangement according to claim 8 wherein the liquid crystal display is controlled by activating the first front transparent electrode and the first rear transparent electrode.

10. A dual display arrangement according to claim 8 wherein the organic electroluminescent display is controlled by activating the second rear transparent electrode and the second front transparent electrode.

11. A dual display arrangement according to claim 8 wherein the liquid crystal display is backlit by activating the second rear transparent electrode and the second front transparent electrode.

12. A dual display arrangement according to claim 8 wherein the liquid crystal display further comprises:
a first front polarizer in front of the first front transparent substrate.

13. A dual display arrangement according to claim 8 wherein the liquid crystal display further comprises:
a first rear polarizer to the rear of the first rear transparent substrate.

14. A dual display arrangement according to claim 8 wherein the organic electroluminescent display further comprises:
a second rear polarizer to the front of the second rear transparent substrate.

15. A dual display arrangement according to claim 8 wherein the organic electroluminescent display further comprises:
a second front polarizer to the front of the second front transparent substrate.

16. A dual display arrangement according to claim 8 further comprising:
a diffuser between the light guide and the first rear transparent substrate.

17. A dual display arrangement according to claim 8 further comprising:
a color filter between the light guide and the first rear transparent substrate.
